(19) United States
(12) Patent Application Publication
(10) Pub. No.: US 2008/0300418 A1
(43) Pub. Date: Dec. 4, 2008

(54) Synthesis of Cardiolipin Analogues and Uses Thereof

(76) Inventors: Moghis U. Ahmad, Wadsworth, IL (US); Murali K. Ukkalam, Lenexa, KS (US); Shoukath M. Ali, Lake Bulff, IL (US); Imran Ahmad, Wadsworth, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/667,232

(22) PCT Filed: Nov. 8, 2005
(86) PCT No.: PCT/US05/40325

§ 371 Date: May 2, 2008

Related U.S. Application Data
(60) Provisional application No. 60/625,845, filed on Nov. 8, 2004.

(51) Int. Cl. C07F 9/202

(52) U.S. Cl. 558/114

(57) ABSTRACT

The invention provides novel synthetic methodologies for preparing cardiolipin, migrated caridiolipin (1,2-positional isomer of cardiolipin) and their analogues having varying fatty acids and/or alkyl chains with varying length and degrees of saturation/unsaturation. The method comprises (a) reacting an optically pure 1,2-O-dialkyl-sn-glycerol or 1,2-O-dialkyl-sn-glycerol with one or more phosphoramidite reagent(s), wherein a phosphite triester is produced; (b) coupling the product of (a) with glycerol, wherein a protected cardiolipin is produced; and (c) deprotecting the protected cardiolipin, such that cardiolipin is prepared. The cardiolipins and analogues thereof, prepared by the present methods, can be incorporated into liposomes, which can also include active agents such as hydrophobic or hydrophilic drugs, antisense nucleotides or diagnostic agents. Such liposomes can be used to treat diseases or can be used in diagnostic and/or analytical assays.

### CROSS-REFERENCE TO RELATED APPLICATIONS

This patent application claims the benefit of U.S. Provisional Patent Application No. 60/625,845, filed on Nov. 8, 2004, the disclosure of which is incorporated herein.

### FIELD OF THE INVENTION

This invention pertains to novel synthetic methods for preparing large quantities of cardiolipin analogues/variants, and compositions containing them. The invention also pertains to liposome formulations, complexes or emulsions containing active agents or drugs and their use in the treatment of diseases in humans and animals.

### BACKGROUND OF THE INVENTION

Liposomal formulations have the capacity to increase the solubility of hydrophobic drugs in aqueous solution. They often reduce the side effects associated with drug therapy and provide flexible tools for developing new formulations of active agents.

Liposomes are commonly prepared from natural phospholipids such as phosphatidylcholine, phosphatidylethanolamine, phosphatidylserine, phosphatidylglycerol, phosphatidic acid, and phosphatidylinositol. Anionic phospholipids, such as phosphatidylglycerol and cardiolipin, can be added to generate a net negative surface charge that provides for colloid stabilization. These components are often purified from natural sources and, in some cases, they can be chemically synthesized.

Cardiolipin (also known as diphosphatidyl glycerol) constitutes a class of complex anionic phospholipids that is typically purified from cell membranes of tissues associated with high metabolic activity, including the mitochondria of heart and skeletal muscles. The negative surface charge of cardiolipin, therefore, stabilizes liposomes against aggregation-dependent uptake. In animal tissues and mitochondria, cardiolipin contains up to 90% of linoleic acid (18:2). Yeast cardiolipin differs in having more oleic (18:1) and palmitoleic (16:1) fatty acids, while the bacterial lipid contains saturated and monoenoic fatty acids with 14 to 18 carbons.

In general, the chemical synthesis of protected cardiolipin involves the selective phosphorylation of the primary alcohol group of phosphatidylglycerol (PG) with phosphatidic acid either: (1) by semi synthetic (enzymatic) methods (See, e.g., Arrigo et al., J. Chem. Soc. Perkin Trans, 21, 2657-2660 (1996)) or (2) by condensation of PG or 2-O-protected glycerols with phosphatidic acid in the presence of triisopropylbenzenesulfonyl chloride (See, e.g., Keana et al., J. Org. Chem., 51, 2297-2299 (1986), Mishina et al., Bioorg. Khim. 13, 1110-1115 (1985), Mishina et al., Bioorg. Khim. 11, 992-994 (1985), Mishina et al., Zh. Org., Khim. 20, 985-988 (1984)). Other synthetic approaches describe the use of phosphorylating agents such as cyclic enediol pyrophosphates, See, e.g., Ramirez et al., Synthesis, 11, 769-770 (1976), Ramirez et al., Tetrahedron, 33, 599-608 (1977), silver salts of phosphatidic acids, See, e.g., De Haas et al., Biochim. Biophys. Acta, 116, 114-124 (1966), Inoue et al., Chem. Pharm. Bull. 11, 1150-1156 (1963) and Inoue et al., Chem. Pharm. Bull. 16, 76-81 (1968), phosphorus oxychloride (See, e.g., Saunders and Schwarz, J. Am. Chem. Soc. 88, 3844-3847 (1966)) and 2-chlorophenyl phosphorodi-(1,2,4-triazolide) (See, e.g., Duralski et al., Tetrahedron Lett. 39, 1607-1610 (1998)). As part of our ongoing research towards the synthesis of cardiolipin and its analogues, we have reported convenient alternate methodologies (See, e.g., Krishna et al., Tetrahedron Lett. 45, 2077-2079 (2004), Krishna et al., Lipids, 39, 595-600 (2004) and Lin et al., Lipids, 39, 285-290 (2004)) for cardiolipin-based phosphoramidite chemistry. Specifically, these methods utilize 2-O-protected glycerols (benzyl, silyl, levulinoyl) along with the phosphoramidite reagents or condensation reagents. The synthesis of these 2-O-protected glycerols, however, involves three additional steps (See, e.g., Dodd et al., J. Chem. Soc. Perkin Trans, 1, 2273-2277 (1976) and Chong and Sokoll, Organic preparations and Procedures int., 25, 639-647 (1993)), resulting in a more expensive process that often has low yields and restricted options for protecting groups. Moreover, 2-O-silyl protected glycerol is prone to migration. Thus, although suitable for the preparation of gram quantities of cardiolipin, these methods are unattractive for the preparation of larger quantities of cardiolipin due to the number of extra steps.

Given these obstacles, new synthetic methods are needed that can prepare large quantities of saturated and unsaturated cardiolipin species having varying fatty acid chain lengths, particularly short-chain cardiolipins. Such methods would increase the availability of a wider variety of cardiolipin species and would diversify the lipids available for developing new liposomal formulations containing active agents.

This invention provides such methods and compositions. This invention describes a concise, complete synthesis of cardiolipin via the phosphonium salt methodology developed by Watanabe (See, e.g., Watanabe et al., Tetrahedron Lett. 35, 123-124 (1994) and Watanabe et al., Tetrahedron Lett. 42, 7407-7410 (1997)). The versatility of this method is exemplified by the use of glycerol and involves only three steps.

These and other advantages of the invention, as well as additional inventive features, will be evident from the description of the invention provided herein.

### BRIEF SUMMARY OF THE INVENTION

The present invention provides novel synthetic methodologies for preparing cardiolipin, migrated cardiolipin and their analogues having varying fatty acids and/or alkyl chains with varying length and degrees of saturation/unsaturation. The method comprises (a) reacting an optically pure 1,2-O-diacyl-sn-glycerol or 1,2-O-dialkyl-sn-glycerol with one or more phosphoramidite reagent(s), wherein a phosphite triester is produced; (b) coupling the product of (a) with glycerol, wherein a protected cardiolipin is produced; and (c) deprotecting the protected cardiolipin, such that cardiolipin is prepared. The cardiolipins and analogues thereof, prepared by the present methods, can be incorporated into liposomes, which can also include active agents such as hydrophobic or hydrophilic drugs, antisense nucleotides or diagnostic agents. Such liposomes can be used to treat diseases or can be used in diagnostic and/or analytical assays.

### BRIEF DESCRIPTION OF THE DRAWINGS

FIG. 1 illustrates the general structure of cardiolipin (1,3-diphosphatidylglycerol);

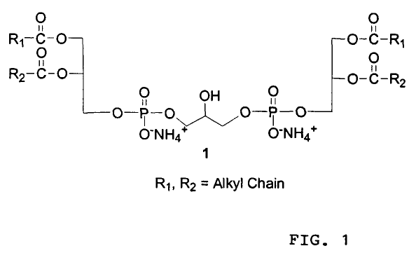

FIG. 2 illustrates the general scheme for synthesizing cardiolipin in accordance with the present invention; and

FIG. 3 illustrates an alternative synthetic scheme for synthesizing migrated cardiolipin (1,2-diphosphatidylglycerol) in accordance with the present invention.

### DETAILED DESCRIPTION OF THE INVENTION

The present invention describes methods for the synthesis of cardiolipin variants and analogues of general formulas I and II.

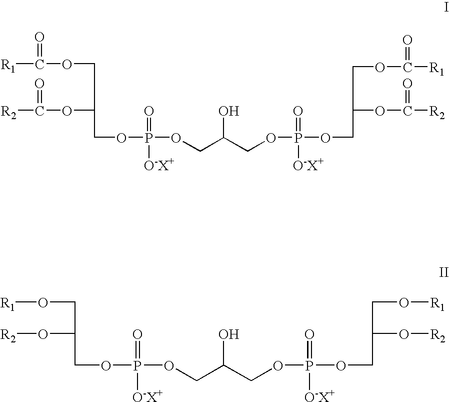

The present invention also provides a method for synthesizing compositions comprising a cardiolipin variant having a structure according to the following general formula III.

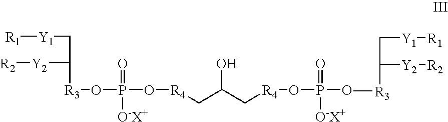

Lastly, the present invention describes the composition and methods for synthesizing migrated cardiolipin variants (positional isomers of cardiolipin) and analogues of general formulas IV and V.

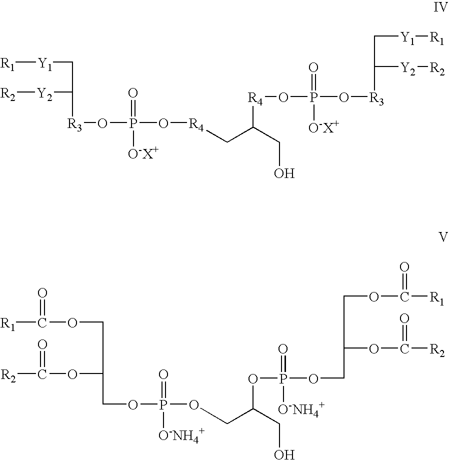

In formulas I, II, III, IV and V, R₁ and R₂ are the same or different and are H, saturated and/or unsaturated alkyl group;

In formulas I, II, III and IV, X is hydrogen, ammonium, sodium, potassium, calcium, barium ion or any other non-toxic cation.

In formulas III and IV, Y₁ and Y₂ are the same or different and are —O—C(O)—, —O—, —S—, —NH—C(O)— or the like;

R₃ is (CH₂)ₙ and n=0-15;

R₄ is a linker which optionally may be added to the molecule depending on the need and applications and comprises alkyl, substituted alkyl, cycloalkyl, substituted cycloalkyl, alkoxy, polyalkyloxy, such as pegylated ether containing from about 1 to about 500 alkyloxy mers (and can have at least about 10 alkyloxy mers, such as at least about 50 alkyloxy mers or at least about 100 alkyloxy mers, such as at least about 200 alkyloxy mers or at least about 300 alkyloxy mers or at least about 400 alkyloxy mers), substituted polyalkyloxy and the like, a peptide, dipeptide, polypeptide, protein, carbohydrate such as glucose, mannose, galactose, polysaccharides and the like.

The term “alkyl” encompasses saturated or unsaturated straight-chain and branched-chain hydrocarbon moieties. The term “substituted alkyl” comprises alkyl groups further bearing one or more substituents selected from hydroxy, alkoxy (of a lower alkyl group), mercapto (of a lower alkyl group), cycloalkyl, substituted cycloalkyl, halogen, cyano, nitro, amino, amido, imino, thio, —C(O)H, acyl, oxyacyl, carboxyl, and the like.

In the most preferred embodiment, Y₁ and Y₂, of formula III, are —O—C(O)— or —O—. In addition, for formula III, R₃ most preferably is CH₂. For formulas I, II, and III, R₁ and R₂ are the same and are C₂ to C₃₄ saturated and/or unsaturated alkyl groups, more preferably between 4 and 14 carbon atoms. In addition, for formulas, I, II and III, X is most preferably a hydrogen or ammonium ion. In the absence of linker (R₄), formula III represents the general structure of cardiolipin.

A general sequence of reactions for the synthesis of cardiolipin of formulas I, II, III, IV and V, having varying fatty acid chain lengths, comprises (a) reacting an alcohol of formula VI with one or more phosphoramidite reagent(s) of general formulas VII wherein X^{a} and X^{b} are phosphate protecting groups and wherein a phosphite trimester is produced; (b) coupling the product of (a) with unprotected glycerol in the presence of an acid catalyst, wherein a protected cardiolipin is produced; and (c) deprotecting the protected cardiolipin, such that the cardiolipin is prepared.

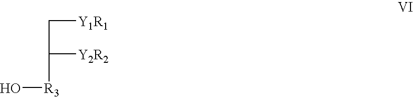

In accordance with the inventive method, R₁, R₂, R₃, Y₁, and Y₂, of Formula VI can be as indicated above with respect to formulas I, II, III, IV or V.

Further, in accordance with the inventive method, the acid catalyst can be any suitable catalyst that can facilitate the reaction. Examples of such catalysts include 4,5-dichloroimidazole, 1H-tetrazole, 5-(4-nitrophenyl)-1H-tetrazole, 5-(3,5-dinitrophenyl)-1H-tetrazole, N-methylimidazolium triflate, and N-methylimidazolium perchlorate. Preferred catalysts are 4,5-dichloroimidazole or 1H-tetrazole.

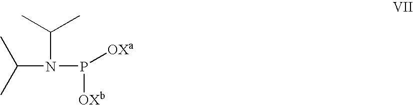

Still further, in accordance with the inventive method, X^{a} and X^{b}, in formula VII, are the same or different and are phosphate protecting groups, preferably a benzyl group, 2-cyanoethyl or silyl group. Other examples of suitable protecting groups include alkyl groups including ethyl, methyl, cyclohexyl, t-butyl; 2-substituted ethyl (including 2-cyanoethyl, 4-cyano-2-butenyl, 2-(methyldiphenylsilyl)ethyl, 2-(trimethylsilyl)ethyl, 2-(triphenylsilyl)ethyl); haloethyl (including 2,2,2-trichloroethyl, 2,2,2-tribromoethyl, 2,2,2-trifluoroethyl) and benzyl groups including 4-chlorobenzyl, fluorenyl-9-methyl, diphenylmethyl and amidates.

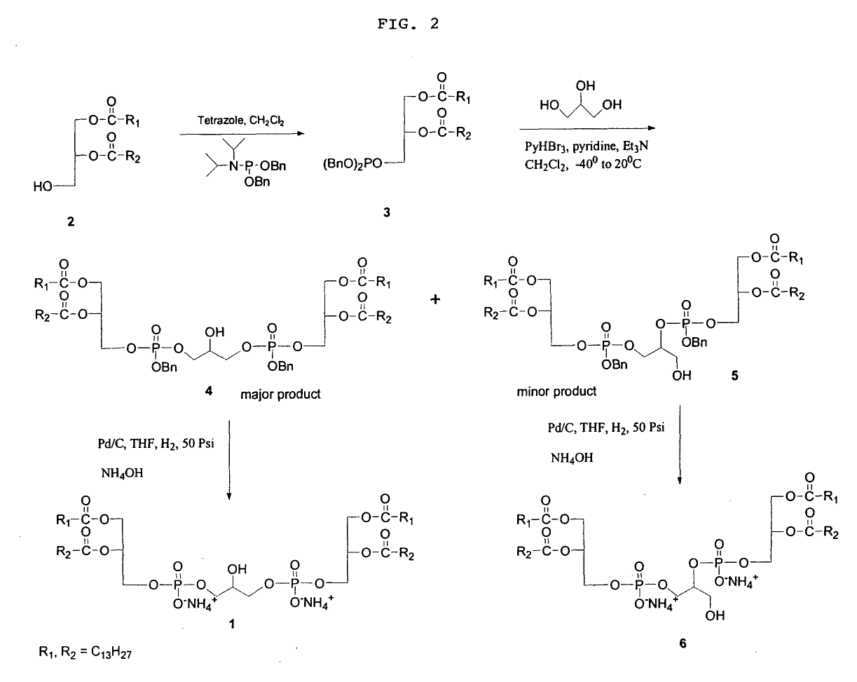

A sequence of reactions for the synthesis of cardiolipin of formulas I and V, having varying fatty acid chain lengths, is illustrated in FIG. 2 and comprises (a) reacting optically pure 1,2-O-diacyl-sn-glycerol 2 with one or more phosphoramidite reagent(s) of general formula VII (X^{a} and X^{b}) are the same or different and are phosphate protecting groups, preferably a benzyl group or methyl group); (b) coupling the product of (a) 3 with an unprotected glycerol in a chlorinated solvent (for example dichloromethane, chloroform or the like) using pyridinium perbromide and phosphonium salt methodology (See, e.g., Watanabe et al., supra) to get 1,3-phosphorylated product 4 (precursor of cardiolipin) and minor amounts of 1,2-phosphorylated product 5 (positional isomer of cardiolipin). The preferred coupling reagent in this context of synthetic methods is dibenzyl diisopropylphosphoramidite. Thereafter, deprotecting the protected cardiolipin followed by conversion to ammonium salt will result in the production of 1,3-diphosphatidyl glycerol 1 (cardiolipin) and 1,2-diphosphatidyl glycerol 6 (migrated cardiolipin or positional isomer of cardiolipin).

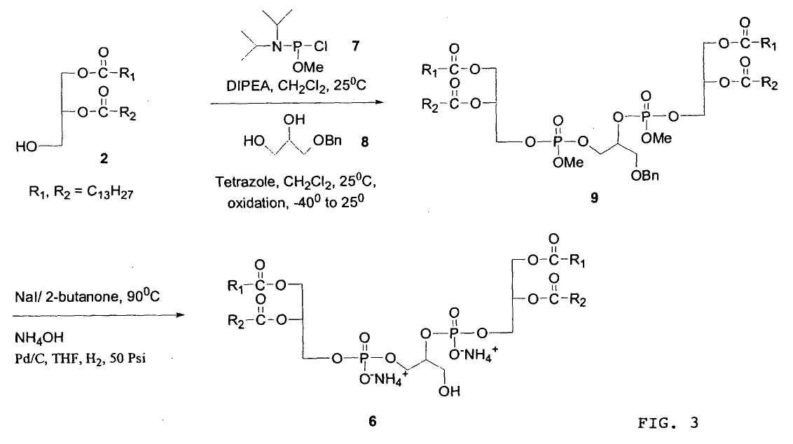

The identity and structure of 1,2-phosphorylated product 6 (migrated cardiolipin) was further confirmed by an independent synthesis of the same, as illustrated by FIG. 3. FIG. 3 illustrates an alternate embodiment of the present invention, which leads to the migrated analogues of cardiolipin 6 as the only product, wherein the phosphatidyl groups are present in 1,2-positions of the glycerol. Accordingly, the sequence comprises (a) treating 1,2-O-diacyl-sn-glycerol 2 with methyl chlorophosphoramidite 7, wherein a phosphorylating agent is produced; (b) reacting the phosphorylating agent with a 3-O-protected glycerol 8 followed by oxidation, wherein a protected migrated cardiolipin 9 is produced; and (c) deprotecting the protected cardiolipin, such that the migrated analogue, as an ammonium salt, of cardiolipin 6 is produced.

The described methods can be used to prepare a variety of novel cardiolipin molecules. For example, the methods can be used to prepare cardiolipin variants in pure form containing short or long fatty acid side chains. Preferred fatty acids range from carbon chain lengths of about C₂ to C₃₄, preferably between about C₄ and about C₂₄, and include tetranoic acid (C_{4:0}), pentanoic acid (C_{5:0}), hexanoic acid (C_{6:0}), heptanoic acid (C_{7:0}), octanoic acid (C_{8:0}), nonanoic acid (C_{9:0}), decanoic acid (C_{10:0}), undecanoic acid (C_{11:0}), dodecanoic acid (C_{12:0}), tridecanoic acid (C_{13:0}), tetradecanoic (myristic) acid (C_{14:0}), pentadecanoic acid (C_{15:0}), hexadecanoic (palmatic) acid (C_{16:0}), heptadecanoic acid (C_{1 7:0}), octadecanoic (stearic) acid (C_{18:0}), nonadecanoic acid (C_{19:0}), eicosanoic (arachidic) acid (C_{20:0}), heneicosanoic acid (C_{21:0}), docosanoic (behenic) acid (C_{22:0}), tricosanoic acid (C_{23:0}), tetracosanoic acid (C_{24:0}), 10-undecenoic acid (C_{11:1}), 11-dodecenoic acid (C_{12:1}), 12-tridecenoic acid (C_{13:1}), myristoleic acid (C_{14:1}), 10-pentadecenoic acid (C_{15:1}), palmitoleic acid (C_{16:1}), oleic acid (C_{18:1}), linoleic acid (C_{18:2}), linolenic acid (C_{18:3}), eicosenoic acid (C_{20:1}), eicosdienoic acid (C_{20:2}), eicosatrienoic acid (C_{20:3}), arachidonic acid (cis-5,8,11,14-eicosatetraenoic acid), and cis-5,8,11,14,17-eicosapentaenoic acid, among others. For ether analogs, the alkyl chain will also range from C₂ to C₃₄, preferably between about C₄ and about C₂₄. Other fatty acid chains also can be employed as R₁ and/or R₂ substituents. Examples of such include saturated fatty acids such as ethanoic (or acetic) acid, propanoic (or propionic) acid, butanoic (or butyric) acid, hexacosanoic (or cerotic) acid, octacosanoic (or montanic) acid, triacontanoic (or melissic) acid, dotriacontanoic (or lacceroic) acid, tetratriacontanoic (or gheddic) acid, pentatriacontanoic (or ceroplastic) acid, and the like; monoethenoic unsaturated fatty acids such as trans-2-butenoic (or crotonic) acid, cis-2-butenoic (or isocrotonoic) acid, 2-hexenoic (or isohydrosorbic) acid, 4-decanoic (or obtusilic) acid, 9-decanoic (or caproleic) acid, 4-dodecenoic (or linderic) acid, 5-dodecenoic (or denticetic) acid, 9-dodecenoic (or lauroleic) acid, 4-tetradecenoic (or tsuzuic) acid, 5-tetradecenoic (or physeteric) acid, 6-octadecenoic (or petroselenic) acid, trans-9-octadecenoic (or elaidic) acid, trans-11-octadecenoic (or vaccinic) acid, 9-eicosenoic (or gadoleic) acid, 11-eicosenoic (or gondoic) acid, 11-docosenoic (or cetoleic) acid, 13-decosenoic (or erucic) acid, 15-tetracosenoic (or nervonic) acid, 17-hexacosenoic (or ximenic) acid, 21-triacontenoic (or lumequeic) acid, and the like; dienoic unsaturated fatty acids such as 2,4-pentadienoic (or β-vinylacrylic) acid, 2,4-hexadienoic (or sorbic) acid, 2,4-decadienoic (or stillingic) acid, 2,4-dodecadienoic acid, 9,12-hexadecadienoic acid, cis-9, cis-12-octadecadienoic (or α-linoleic) acid, trans-9, trans-12-octadecadienoic (or linlolelaidic) acid, trans-10,trans-12-octadecadienoic acid, 11,14-eicosadienoic acid, 13,16-docosadienoic acid, 17,20-hexacosadienoic acid and the like; trienoic unsaturated fatty acids such as 6,10,14-hexadecatrienoic (or hiragonic) acid, 7,10,13-hexadecatrienoic acid, cis-6, cis-9-cis-12-octadecatrienoic (or γ-linoleic) acid, trans-8, trans-10-trans-12-octadecatrienoic (or β-calendic) acid, cis-8, trans-10-cis-12-octadecatrienoic acid, cis-9, cis-12-cis-15-octadecatrienoic (or α-linolenic) acid, trans-9, trans-12-trans-15-octadecatrienoic (or α-linolenelaidic) acid, cis-9, trans-11-trans-13-octadecatrienoic (or α-eleostearic) acid, trans-9, trans-11-trans-13-octadecatrienoic (or β-eleostearic) acid, cis-9, trans-11-cis-13-octadecatrienoic (or punicic) acid, 5,8,11-eicosatrienoic acid, 8,11,14-eicosatrienoic acid and the like; tetraenoic unsaturated fatty acids such as 4,8,11,14-hexadecatetraenoic acid, 6,9,12,15-hexadecatetraenoic acid, 4,8,12,15-octadecatetraenoic (or moroctic) acid, 6,9,12,15-octadecatetraenoic acid, 9,11,13,15-octadecatetraenoic (or α- or β-parinaric) acid, 9,12,15,18-octadecatetraenoic acid, 4,8,12,16-eicosatetraenoic acid, 6,10,14,18-eicosatetraenoic acid, 4,7,10,13-docasatetraenoic acid, 7,10,13,16-docosatetraenoic acid, 8,12,16,19-docosatetraenoic acid and the like; penta- and hexa-enoic unsaturated fatty acids such as 4,8,12,15,18-eicosapentaenoic (or timnodonic) acid, 4,7,10,13,16-docosapentaenoic acid, 4,8,12,15,19-docosapentaenoic (or clupanodonic) acid, 7,10,13,16,19-docosapentaenoic, 4,7,10,13,16,19-docosahexaenoic acid, 4,8,12,15,18,21-tetracosahexaenoic (or nisinic) acid and the like; branched-chain fatty acids such as 3-methylbutanoic (or isovaleric) acid, 8-methyldodecanoic acid, 10-methylundecanoic (or isolauric) acid, 11-methyldodecanoic (or isoundecylic) acid, 12-methyltridecanoic (or isomyristic) acid, 13-methyltetradecanoic (or isopentadecylic) acid, 14-methylpentadecanoic (or isopalmitic) acid, 15-methylhexadecanoic, 10-methylheptadecanoic acid, 16-methylheptadecanoic (or isostearic) acid, 18-methylnonadecanoic (or isoarachidic) acid, 20-methylheneicosanoic (or isobehenic) acid, 22-methyltricosanoic (or isolignoceric) acid, 24-methylpentacosanoic (or isocerotic) acid, 26-methylheptacosanoic (or isomonatonic) acid, 2,4,6-trimethyloctacosanoic (or mycoceranic or mycoserosic) acid, 2-methyl-cis-2-butenoic(angelic) acid, 2-methyl-trans-2-butenoic (or tiglic) acid, 4-methyl-3-pentenoic (or pyroterebic) acid and the like.

The invention also provides a cardiolipin or cardiolipin analogue and positional isomer of cardiolipin and cardiolipin analogue prepared in accordance with the inventive method. Most preferably, the cardiolipin prepared by the inventive method comprises a short fatty acid chain (i.e., a “short chain cardiolipin”). A short fatty acid chain comprises between about 2 and about 14 carbon atoms, and can have between about 4 (or about 6) and about 12 carbon atoms, such as between about 8 and about 10 carbon atoms. Alternatively, the cardiolipin produced by the inventive method can comprise a long chain fatty acid chain (i.e., a “long chain cardiolipin”). A long fatty acid chain comprises between about 14 and about 34 carbon atoms, such as between about 14 (or between about 20) and about 24 carbon atoms. The inventive method is not limited to the production of short or long chain cardiolipin species exclusively. Indeed, a cardiolipin containing fatty acid/alkyl chains of intermediate length can also be prepared by the inventive method.

The invention described above is an elegant and efficient method of synthesizing cardiolipin. The routes are short and proceed in good overall yield. The deprotection can be accomplished by a method depending on the protecting group. For example, a benzyl or methyl group can be removed by treatment with NaI, 2-cyanoethyl and fluorenylmethyl groups by treatment with a tertiary base such as triethylamine, a silyl group can be deprotected with fluoride ion or acidic medium. The synthetic methods described herein can be modified in any suitable manner. For example, phosphoramidites and phosphate esters can be prepared using a variety of acid catalysts, including 4,5-dichloroimidazole, 5-(4-nitrophenyl)-1H-tetrazole, 5-(3,5-dinitrophenyl)-1H-tetrazole, N-methylimidazolium triflate, and N-methylimidazolium perchlorate. Likewise, tert-butylhydroperoxide can be used as an alternative oxidant. The described methods can be further modified in any suitable manner known in the art.

The cardiolipin analogues and their positional isomers, described herein, may be used as active agents for medicinal use in the treatment of a human disease and may be used as active agents for cosmetic use.

In addition, the cardiolipin molecules described herein and cardiolipin analogues produced by the inventive method can be used in lipid formulations, such as liposomal compositions. Complexes, emulsions and other formulations including the inventive cardiolipin also are within the scope of the present invention. Such formulations according to the present invention can be prepared by any suitable technique. The invention provides a method for preparing a liposome or other lipid composition, comprising preparing a cardiolipin or cardiolipin analogue as described herein and including the cardiolipin or cardiolipin analogue in a lipid formulation, such as a liposome. The invention also includes such lipid compositions including the inventive cardiolipin and/or cardiolipin analogues.

Further, in addition to the inventive cardiolipin, the liposomal composition, complex, emulsion and the like can include other lipids. Thus, for example, the composition can include one or more phosphatidylcholines, such as, for example, dimyristoylphosphatidylcholine, distearoylphosphatidylcholine, dioleylphosphatidylcholine, dipalmitoylphosphatidylcholine, diarachidonoylphosphatidylcholine, egg phosphatidylcholine, soy phosphatidylcholine, hydrogenated soy phosphatidylcholine, and mixtures thereof. Alternatively or additionally, the composition can include one or more phosphatidylglycerols, such as dimyristoylphosphatidylglycerol, distearoylphosphatidylglycerol, dioleylphosphatidylglycerol, dipalmitoylphosphatidylglycerol, diarachidonoylphosphatidylglycerol, and mixtures thereof. Alternatively or additionally, the composition can include one or more sterols, such as cholesterol, derivatives of cholesterol, coprostanol, cholestanol, cholestane, cholesterol hemisuccinate, cholesterol sulfate, and mixtures thereof. Preferably, in addition to the cardiolipin or cardiolipin analogue, the composition includes a phosphatidylcholine, a sterol, and a tocopherol (e.g., α tocopherol).

Still further, in addition to the cardiolipin, positional isomer of cardiolipin, and, optionally, other lipids, the composition also can include stabilizers, absorption enhancers, antioxidants, phospholipids, biodegradable polymers and medicinally active agents among other ingredients. In some embodiments, it is preferable for the inventive composition, especially liposomal composition, to include one or more targeting agents, such as a carbohydrate or protein or other ligand that binds to a specific substrate, for example, that recognizes cellular receptors. The inclusion of such agents (such as a carbohydrate or one or more proteins selected from groups of proteins consisting of antibodies, antibody fragments, peptides, peptide hormones, receptor ligands such as an antibody to a cellular receptor and mixtures thereof) can facilitate targeting a liposome to a predetermined tissue or cell type.

For medicinal use, the composition also can include one or more active agents. A single active agent can be included, or a mixture of active agents (e.g., two or more active agents) can be included within the composition. Active agents (or “drugs”) can be present in any suitable manner in the composition. For example, they can be complexed with the cardiolipin or positional isomer of the cardiolipin or cardiolipin analogue in the composition. Additionally, in an alternative embodiment, when the composition is a liposomal composition, one or more active agents can be entrapped within the liposomes.

Active agents which are compatible with the present invention include, for example, but are not limited to, agents which act on the peripheral nerves, adrenergic receptors, cholinergic receptors, the skeletal muscles, the cardiovascular system, smooth muscles, the blood circulatory system, synaptic sites, neuroeffector junctional sites, endocrine and hormone systems, the immunological system, the reproductive system, the skeletal system, the alimentary and excretory systems, the histamine system and the central nervous system. Suitable agents may be selected from, for example, but not limited to, proteins, enzymes, hormones, nucleotides (including sense and antisense oligonucleotides (See, e.g., U.S. Pat. No. 6,126,965), polynucleotides, nucleoproteins, polysaccharides, glycoproteins, lipoproteins, polypeptides and steroids. Active agents can be analgesics, anesthetics, anti-arrythmic agents, antibiotics, antiallergic agents, antifungal agents, anticancer agents, anticoagulants, antidepressants, antidiabetic agents, anti-epilepsy agents, anti-inflammatory corticosteroids, agents for treating Alzheimers or Parkinson's disease, antiulcer agents, anti-protozoal agents, anxiolytics, thyroids, anti-thyroids, antivirals, anoretics, bisphosphonates, cardiac inotropic agents, cardiovascular agents, corticosteroids, diuretics, dopaminergic agents, gastrointestinal agents, hemostatics, hypercholesterol agents, antihypertensive agents (e.g., dihydropyridines), antidepressants, and cox-2 inhibitors, immunosuppressive agents, anti-gout agents, anti-malarials, steroids, terpinoids, triterpines, retinouds; anti-ulcer H2-receptor antagonists, hypoglycemic agents, moisturizers, cosmetics (e.g. agents in the treatment of alopecia), anti-migraine agents, antimuscarinic agents, antiinflammatory agents, such as agents for treating rheumatology, arthritis, psoriasis, inflammatory bowel disease, Crohn's disease; or agents for treating demyelinating diseases including multiple sclerosis, ophthalmic agents, vaccines (e.g., against pneumonia, hepatitis A, hepatitis B, hepatitis C, cholera toxin B subunit, influenza virus, typhoid, plasmodium falciparun, diptheria, tetanus, HSV, tuberculosis, HIV, SARS virus, pordetela pertussis, measueles, mumps and rubella vaccine (MMV), bacterial toxoids, vaccinea virus, adenovirus, canary, polio virus, bacillus calmette guerin (BCG), klebsiella pneumonia, etc.), histamine receptor antagonists, hypnotics, kidney protective agents, lipid regulating agents, muscle relaxants, neuroleptics, neurotropic agents, opioid agonists and antagonists, parasympathomimetics, protease inhibitors, prostglandins, sedatives, sex hormones (e.g., estrogen, androgen), stimulants, sympathomimetics, vasodilators and xanthins and synthetic analogs of these species. The therapeutic agents can be nephrotoxic, such as cyclosporins and amphotericin B, or cardiotoxic, such as amphotericin B and paclitaxel. Exemplary anticancer agents include melphalan, chlormethine, extramustinephosphate, uramustine, ifosfamide, mannomustine, trifosfamide, streptozotocin, mitobronitol, mitoxantrone (see., e.g., published international patent application WO 02/32400), methotrexate, fluorouracil, cytarabine, tegafur, idoxide, taxanes (e.g., taxol, paclitaxel, etc., see published international patent application WO 00/01366), daunomycin, daunorubicin, bleomycin, amphotericin, carboplatin, cisplatin, paclitaxel, BCNU, vinva alkaloids (e.g., vincristine, vinorelbine (see, e.g., published international patent application WO 03/018018), and the like) camptothecin and derivatives thereof (e.g., SN38 (see, e.g., published international patent application WO 02/058622), irinotecan (see, e.g., published international patent application WO 03/030864), and the like), antracyclines, antibodies, cytoxines, doxorubicin, etopside, cytokines, ribozymes, interferons, oligonucleotides and functional derivatives of the foregoing. Additional examples of drugs which may be delivered according to the method include, prochlorperzine edisylate, ferrous sulfate, aminocaproic acid, mecamylamine hydrochloride, procainamide hydrochloride, amphetamine sulfate, methamphetamine hydrochloride, benzamphetamine hydrochloride, isoproterenol sulfate, phenmetrazine hydrochloride, bethanechol chloride, methacholine chloride, pilocarpine hydrochloride, atropine sulfate, scopolamine bromide, isopropamide iodide, tridihexethyl chloride, phenformin hydrochloride, methylphenidate hydrochloride, theophylline cholinate, cephalexin hydrochloride, diphenidol, meclizine hydrochloride, prochlorperazine maleate, phenoxybenzamine, thiethylperzine maleate, anisindone, diphenadione erythrityl tetranitrate, digoxin, isoflurophate, acetazolamide, methazolamide, bendroflumethiazide, chloropromaide, tolazamide, chlormadinone acetate, phenaglycodol, allopurinol, aluminum aspirin, methotrexate, acetyl sulfisoxazole, erythromycin, hydrocortisone, hydrocorticosterone acetate, cortisone acetate, dexamethasone and its derivatives such as betamethasone, triamcinolone, methyltestosterone, 17-S-estradiol, ethinyl estradiol, ethinyl estradiol 3-methyl ether, prednisolone, 17a-hydroxyprogesterone acetate, 19-norprogesterone, norgestrel, norethindrone, norethisterone, norethiederone, progesterone, norgesterone, norethynodrel, aspirin, indomethacin, naproxen, fenoprofen, sulindac, indoprofen, nitroglycerin, isosorbide dinitrate, propranolol, timolol, atenolol, alprenolol, cimetidine, clonidine, imipramine, levodopa, chlorpromazine, methyldopa, dihydroxyphenylalanine, theophylline, calcium gluconate, ketoprofen, ibuprofen, cephalexin, erythromycin, haloperidol, zomepirac, ferrous lactate, vincamine, diazepam, phenoxybenzamine, diltiazem, milrinone, mandol, quanbenz, hydrochlorothiazide, ranitidine, flurbiprofen, fenufen, fluprofen, tolmetin, alclofenac, mefenamic, flufenamic, difuinal, nimodipine, nitrendipine, nisoldipine, nicardipine, felodipine, lidoflazine, tiapamil, gallopamil, amlodipine, mioflazine, lisinolpril, enalapril, enalaprilat captopril, ramipril, famotidine, nizatidine, sucralfate, etintidine, tetratolol, minoxidil, chlordiazepoxide, diazepam, amitriptyline, and imipramine. Further examples are proteins and peptides which include, but are not limited to, bone morphogenic proteins, insulin, colchicine, glucagon, thyroid stimulating hormone, parathyroid and pituitary hormones, digestive hormones, calcitonin, renin, prolactin, corticotrophin, thyrotropic hormone, follicle stimulating hormone, chorionic gonadotropin, gonadotropin releasing hormone, bovine somatotropin, porcine somatotropin, oxytocin, vasopressin, GRF, somatostatin, lypressin, pancreozymin, luteinizing hormone, LHRH, LHRH agonists and antagonists, leuprolide, interferons (e.g., consensus interferon, interferon a-2a, interferon a-2b, a-, b-, or g-interferons), interleukins, growth hormones such as human growth hormone and its derivatives such as methione-human growth hormone and des-phenylalanine human growth hormone, bovine growth hormone and porcine growth hormone, fertility inhibitors such as the prostaglandins, fertility promoters, growth factors such as insulin-like growth factor, coagulation factors, pancreas hormone releasing factor, analogs and derivatives of these compounds, and pharmaceutically acceptable salts of these compounds, or their analogs or derivatives. The therapeutic agent can be a mixture of drugs or agents (e.g., two or more agents) that can be beneficially co-administered in the liposome formulation.

Generally, liposomes can have a net neutral, negative or positive charge. For example, positive liposomes can be formed from a solution containing phosphatidylcholine, cholesterol, cardiolipin and enough stearylamine to overcome the net negative charge of cardiolipin. Negative liposomes can be formed from solutions containing phosphatidyl choline, cholesterol, and/or cardiolipin variants prepared by the methods described herein.

Further, the liposomes of the present invention can be multi or unilamellar vesicles, depending on the particular composition and procedure used to make them. Liposomes can be prepared to have substantially homogeneous sizes in a selected size range, such as about 1 micron or less, or about 500 nm or less, about 200 nm or less, or about 100 nm or less. One effective sizing method involves extruding an aqueous suspension of the liposomes through a series of polycarbonate membranes having a selected uniform pore size; the pore size of the membrane will correspond roughly with the largest sizes of liposomes produced by extrusion through that membrane.

Still further, the liposomal (or other lipid) composition can be in any desired form. For example, for pharmaceutical use, the composition can be ready for administration to a patient. Alternatively, the composition can be in dried or lyophilized form. Where the composition is dried or lyophilized, preferably the composition includes a cryoprotectant as well. Suitable cryoprotectants include, for example, sugars such as trehalose, maltose, lactose, sucrose, glucose, and dextran, with the most preferred sugars, from a performance point of view, being trehalose and sucrose. Other more complicated sugars can also be used, such as, for example, aminoglycosides, including streptomycin and dihydrostreptomycin.

Any suitable method can be employed to form the liposomes. For example, lipophilic liposome-forming ingredients, such as phosphatidylcholine, a cardiolipin prepared by the methods described above, cholesterol and α-tocopherol can be dissolved or dispersed in a suitable solvent or combination of solvents and dried. Suitable solvents include any non-polar or slightly polar solvent, such as t-butanol, ethanol, methanol, chloroform, or acetone that can be evaporated without leaving a pharmaceutically unacceptable residue. Drying can be by any suitable means, such as by lyophilization. The dehydration is typically achieved under vacuum and can take place either with or without prior freezing of the liposome preparation. Hydrophilic ingredients can be dissolved in polar solvents, including water.

Mixing the dried lipophilic ingredients with the hydrophilic mixture can form liposomes. Mixing the polar solution with the dry lipid film can be by any means that strongly homogenizes the mixture. Vortexing, magnetic stirring and/or sonicating can effect the homogenization.

Where active agents (or a mixture of active agents) are included in the liposomes, the invention provides a method for retaining a drug in a liposome. In accordance with the method, a cardiolipin or positional isomer of cardiolipin or cardiolipin analogue is prepared as described herein, and the cardiolipin or positional isomer of the cardiolipin or cardiolipin analogue and a drug or drugs (e.g., an active agent or a mixture of active agents) is included within a liposome. For example, the active agent(s) can be dissolved or dispersed in a suitable solvent and added to the liposome mixture prior to mixing. Typically, hydrophilic active agents will be added directly to the polar solvent and hydrophobic active agents will be added to the nonpolar solvent used to dissolve the other ingredients, but this is not required. The active agent could be dissolved in a third solvent or solvent mix and added to the mixture of the polar solvent with the lipid film prior to homogenizing the mixture.

Liposomes can be coated with biodegradable polymers such as sucrose, epichlorohydrin, branched hydrophilic polymers of sucrose, polyethylene glycols, polyvinyl alcohols, methoxypolyethylene glycol, ethoxypolyethylene glycol, polyethylene oxide, polyoxyethylene, polyoxypropylene, cellulose acetate, sodium alginate, N,N-diethylaminoacetate, block copolymers of polyoxyethylene and polyoxypropylene, polyvinyl pyrrolidone, polyoxyethylene X-lauryl ether wherein X is from 9 to 20, and polyoxyethylene sorbitan esters.

Antioxidants can be included in the liposomal composition or other lipid composition. Suitable antioxidants include compounds such as ascorbic acid, tocopherol, and deteroxime mesylate.

Absorption enhancers can be included in the liposomal composition or other lipid composition. Suitable absorption enhancers include Na-salicylate-chenodeoxy cholate, Na deoxycholate, polyoxyethylene 9-lauryl ether, chenodeoxy cholate-deoxycholate and polyoxyethylene 9-lauryl ether, monoolein, Na tauro-24,25-dihydrofusidate, Na taurodeoxycholate, Na glycochenodeoxycholate, oleic acid, linoleic acid, linolenic acid. Polymeric absorption enhancers can also be included, such as polyoxyethylene ethers, polyoxyethylene sorbitan esters, polyoxyethylene 10-lauryl ether, polyoxyethylene 16-lauryl ether and azone (1-dodecylazacycloheptane-2-one).

The inventive lipid (e.g., liposomal) composition also can include one or more pharmaceutically acceptably excipients. For example, pharmaceutically suitable excipients include solid, semi-solid or liquid diluents, fillers and formulation auxiliaries of all kinds. The invention also includes pharmaceutical preparations in dosage units. This means that the preparations are in the form of individual parts including, for example, vials, syringes, capsules, pills, suppositories, or ampoules, of which the content of the liposome formulation of active agent corresponds to a fraction or a multiple of an individual dose. The dosage units can contain, for example, 1, 2, 3, or 4 individual doses, or ½, ⅓, or ¼ of an individual dose. An individual dose preferably contains the amount of active agent which is given in one administration and which usually corresponds to a whole, a half, a third, or a quarter of a daily dose.

Tablets, dragees, capsules, pills, granules, suppositories, solutions, suspensions and emulsions, pastes, ointments, gels, creams, lotions, powders and sprays can be suitable pharmaceutical preparations. Suppositories can contain, in addition to the liposomal active agent, suitable water-soluble or water-insoluble excipients. Suitable excipients are those in which the inventive liposomal active agent is sufficiently stable to allow for therapeutic use, for example polyethylene glycols, certain fats, and esters or mixtures of these substances. Ointments, pastes, cream, and gels can also contain suitable excipients in which the liposomal active agent is stable. The composition also can be formulated for injection (e.g., intravenously, interstitially, intratumorally, etc) by the inclusion of one or more excipients (e.g., buffered saline) suitable for injection.

The active agent or its pharmaceutical preparations can be administered intravenously, subcutaneously, locally, orally, parenterally, intraperitoneally, and/or rectally or by direct injection into tumors or sites in need of treatment by such methods as are known or developed. Cardiolipin or positional isomer of cardiolipin and cardiolipin-analogue based formulations also can be administered topically, e.g., as a cream, skin ointment, dry skin softener, moisturizer, etc.

Where the composition includes one or more active agents (e.g., a mixture of active agents), the invention provides for the use of the composition to prepare a medicament for the treatment of a disease. In this sense, the invention also provides a method for treating a human or animal disease. In accordance with the inventive method, the inventive composition containing one or a mixture of active agents is exposed to (administered to) a human or animal patient in need of such treatment. In this manner, the active agent(s) is/are delivered to the patient.

The method can be used to administer one or more active agents. It is contemplated that the method is general for active agents that are stable in the presence of surfactants. Hydrophilic active agents are suitable and can be included in the interior of the liposomes such that the liposome bilayer creates a diffusion barrier preventing it from randomly diffusing throughout the body. Hydrophobic active agents are thought to be particularly well suited for use in the present method because they not only benefit by exhibiting reduced toxicity, but they tend to be well solubilized in the lipid bilayer of liposomes.

Suitable diseases for treatment will depend on the selection of active agents, such as described herein. However, a preferred disease is cancer, in which instance, at least one active agent incorporated into the composition is an anticancer agent. Chemotherapeutic agents are well suited for such use. Liposome formulations containing chemotherapeutic agents may be injected directly into the tumor tissue for delivery of the chemotherapeutic agent directly to cancer cells. In some cases, particularly after resection of a tumor, the liposome formulation can be implanted directly into the resulting cavity or may be applied to the remaining tissue as a coating. In cases in which the liposome formulation is administered after surgery, it is possible to utilize liposomes having larger diameters of about 1 micron since they do not have to pass through the vasculature.

The invention also is directed to methods of delivering active agents (or mixtures of active agents) to cells. The methods can be carried out by preparing liposomes that include active agents and cardiolipin variants/analogues as synthesized by the above disclosed methods. The liposomes are then delivered to a cell or cells, which can be in vitro or in vivo, as desired. In vivo administration can be achieved as described herein or as otherwise known to those of ordinary skill. For in vitro use, delivery of the active agent(s) can be carried out by adding the composition (e.g., liposomes) to the cell culture medium, for example.

The following examples further illustrate the invention but, of course, should not be construed as limiting its scope in any way.

### EXAMPLE 1

### Synthesis of Tetramyristoyl Cardiolipin

1A. 1,3-bis[(1,2-dimyristoyl-sn-glycero-3)-phosphoryl]glycerol Dibenzylester (Cardiolipin Dibenzyl Ester) 4

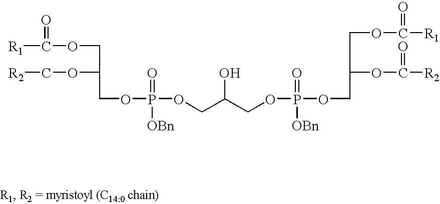

To a solution of 1,2-Dimyristoyl-sn-glycerol (7.35 g, 14.35 mmol) and tetrazole (38.4 mL of 0.45 M sol in acetonitrile, 17.22 mmol) in 120 mL anhydrous CH₂Cl₂, dibenzyl diisopropyl phosphoramidite (5.45 g, 15.79 mmol) was added and stirred at room temperature for 2 h. The contents were diluted with 100 mL of CH₂Cl₂ and washed with 5% aqueous NaHCO₃ (2×50 mL), brine (2×50 mL), dried over Na₂SO₄, concentrated in vacuo and the oily residue (10.8 g) was dried in a desiccator under vacuum for 8 hours and used as such in the next reaction.

A solution of above phosphite, glycerol (0.53 g, 5.74 mmol), pyridine (8.75 mL, 108.4 mmol) and Et₃N (9.4 mL, 71.75 mmol) in CH₂Cl₂ (100 mL) was cooled to −40° C. and pyridinium tribromide (6.88 g, 21.52 mmol) was added at a time. The mixture was stirred at the same temperature for 1 hour and gradually allowed to attain room temperature over a period of 2 hours and treated with water (30 mL). The contents were diluted with EtOAc (250 mL) and the organic layer was washed successively with 5% aqueous NaHCO3 (2×50 mL), water (100 mL) and brine (100 mL), dried (Na₂SO₄) and concentrated. The residue was purified on SiO₂ (8% acetone in CH₂Cl₂) to give 4.2 grams (53%) of the required product as colorless syrup and 1,2-bis [(1,2-dimyristoyl-sn-glycero-3)-phosphoryl]glycerol dibenzylester (migrated cardiolipin dibenzyl ester). TLC (SiO₂) hexane/EtOAc (3:2) Rf˜0.44 (for 1,3-derivative), Rf˜0.47 (for 1,2-derivative). ¹H NMR δ (CDCl₃, 500 MHz) 0.88 (t, J=7.0 Hz, 12H), 1.22-1.34 (m, 80H), 1.54-1.63 (m, 8H), 2.24-2.31 (m, 8H), 3.86-4.19 (m, 11H), 4.25-4.31 (m, 2H), 5.02-5.11 (m, 4H), 5.14-5.21 (m, 2H), 7.31-7.39 (m, 10H). ¹H NMR (for 1,2-isomer) 5 δ (CDCl₃, 500 MHz) 0.88 (t, J=7.0 Hz, 12H), 1.22-1.34 (m, 80H), 1.54-1.62 (m, 8H), 2.23-2.31 (m, 8H), 4.02-4.31 (m, 12H), 4.60-4.64 (m, 1H), 5.02-5.11 (m, 4H), 5.14-5.21 (m, 2H), 7.31-7.39 (m, 10H).

1B. 1,3-bis[(1,2-dimyristoyl-sn-glycero-3-phosphoryl]glycerol Diammonium Salt (1)

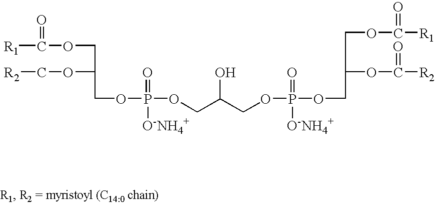

A solution of protected cardiolipin 4 (2.5 g, 1.65 mmol) in tetrahydrofuran (40 mL) was hydrogenated at 50 psi over 10% Pd/C (900 mg) for 10 hours. The catalyst was filtered off over celite bed, treated with 4 mL of 30% ammonia solution and concentrated, the residue was dissolved in CHCl₃, filtered through a 0.25μ filter and precipitated with acetone to give C₁₄ cardiolipin (1.75 g, 83%) as a white solid. TLC (SiO₂) CHCl₃/MeOH/NH₄OH (6.5:2.5:0.5) R_{f}˜0.40. ¹H NMR (1) δ (CDCl₃, 500 MHz) 0.88 (t, J=7.0 Hz, 12H), 1.22-1.34 (br s, 80H), 1.52-1.66 (m, 8H), 2.26-2.34 (m, 8H), 3.06 (bs, 1H), 3.82-3.98 (m, 9H), 4.12-4.18 (m, 2H), 4.35-4.42 (m, 2H), 5.14-5.24 (m, 2H), 7.41 (bs, 8H). ³¹P NMR δ (CDCl₃, 161 MHz, 85% H₃PO₄ as external standard) 0.78. FTIR (ATR) 3214, 3041, 2956, 2917, 2873, 2849,1737, 1467, 1417, 1378, 1343, 1328, 1304, 1279, 1255, 1202, 1181, 1091, 1066, 987, 836, 721, 539, 530 cm⁻¹. ESI-MS (negative), m/z 1239.9 (M-2NH₄⁺+H⁺), 1011.9 (M-2NH₄⁺—RCOO⁻), 619.6 (M-2NH₄⁺)²⁻. ¹H NMR (for 1,2-isomer) (6) ¹H NMR δ (CDCl₃, 500 MHz) 0.88 (t, J=7.0 Hz, 12H), 1.22-1.34 (m, 80H), 1.52-1.63 (m, 8H), 2.25-2.33 (m, 8H), 2.92 (bs, 1H), 3.59-3.69 (m, 2H), 3.86-3.98 (m, 6H), 4.12-4.18 (m, 2H), 4.28-4.39 (m, 3H), 5.16-5.23 (m, 2H), 7.43 (br s, 8H). ³¹P NMR δ (CDCl₃, 161 MHz, 85% H₃PO₄ as external standard) 0.34, 0.68. FTIR (ATR) 3220, 3034, 2957, 2919, 2872, 2851,1737, 1466, 1416, 1378, 1345, 1328, 1293, 1279, 1255, 1202, 1181, 1093, 1063, 980, 836, 764, 721, 530 cm⁻. ESI-MS (negative), m/z 1239.9 (M-2NH₄⁺+H⁺), 1011.6 (M-2NH₄⁺—RCOO⁻), 619.5 (M-2NH₄⁺)²⁻.

### EXAMPLE 2

### Synthesis of Migrated Tetramyristoyl Cardiolipin (A Positional Isomer of Cardiolipin)

2A. 3-Benzyl-1,2-bis[(1,2-dimyristoyl-sn-glycero-3)phosphoryl]glycerol Dimethyl Ester (9)

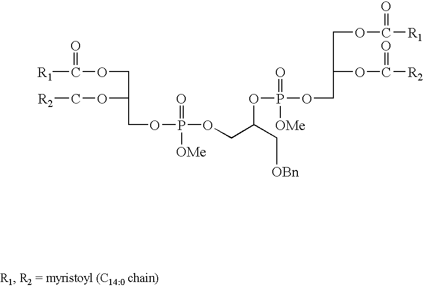

To a solution of N,N-diisopropylmethylphosphonamidic chloride 7 (2.08 g, 10.63 mmol) and anhydrous N,N-diisopropylethylamine (1.85 mL, 10.63 mmol) in CH₂Cl₂ (20 mL) was added dropwise a solution of 1,2-O-dimyristoyl-sn-glycerol (4.95 g, 9.66 mmol) in CH₂Cl₂ (45 mL) at room temperature over 30 minutes. After addition, the reaction mixture was stirred at room temperature for 1.5 hours and then 1H-tetrazole of 3 wt % solution in acetonitrile (25.76 mL, 11.59 mmol) was added. To this reaction mixture, a solution of 3-O-benzylglycerol 8 (0.703 g, 3.86 mmol) in CH₂Cl₂ (10 mL) was added dropwise. The reaction mixture was stirred at room temperature for 2 hours. The reaction mixture was then cooled to −40° C. and a solution of tert-butylhydroperoxide (2.9 mL of 5.5M sol in decane, 14.49 mmol) was added. The mixture was warmed to 25° C., diluted with 200 mL of CH₂Cl₂, washed with water (2×100 mL), and brine (2×100 mL). The organic layer was dried over anhydrous Na₂SO₄ and concentrated in vacuo to yield an oil residue. The residue was purified by flash chromatography on silica gel eluting with hexane/ethyl acetate (2:1 to 1:1) to afford 9 as colorless oil. Yield 4.19 g (80%). TLC (Hexane/EtOAc 1:1) R_{f}˜0.46. ¹H NMR δ (CDCl₃, 500 MHz) 0.88 (t, J=7.0 Hz, 12H), 1.22-1.34 (m, 80H), 1.52-1.66 (m, 8H), 2.22-2.29 (m, 8H), 3.67-3.78 (m, 2H), 3.75 (dt, J=11.4, 3.0 Hz, 6H), 4.11-4.37 (m, 10H), 4.55 (d, J=11.8 Hz, 2H), 4.64-4.67 (m, 1H), 5.20-5.28 (m, 2H), 7.28-7.36 (m, 5H).

2B. 1,2-Bis[(1,2-dimyristolyl-sn-glycero-3)phosphoryl]glycerol Diammonium Salt (Positional Isomer of Cardiolipin) (6)

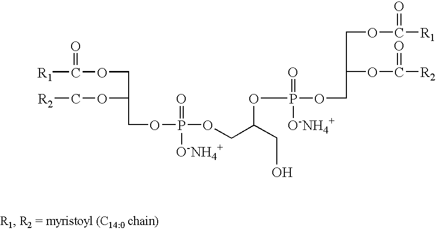

To a stirred solution of compound 9 (2.45 g, 1.8 mmol) in 2-butanone (40 mL) was added NaI (0.811 g, 5.4 mmol), and the reaction mixture was refluxed for 3 hours and then cooled to 25° C. The volatiles were evaporated and the residue was purified on SiO₂ (10% methanol in CH₂Cl₂ containing 1% of ammonia) to give 1.92 grams (72%) of the product as colorless semisolid. TLC (SiO₂) CHCl₃/MeOH/NH₄OH (6.5:2.0:0.5) R_{f}˜0.64. ¹H NMR δ (CDCl₃, 500 MHz) 0.88 (t, J=7.0 Hz, 12H), 1.22-1.34 (m, 80H), 1.52-1.66 (m, 8H), 2.22-2.29 (m, 8H), 3.50-3.58 (m, 2H), 3.84-3.98 (m, 6H), 4.06-4.16 (m, 2H), 4.26-4.37 (m, 2H), 4.44-4.56 (m, 3H), 5.16-5.23 (m, 2H), 7.28-7.36 (m, 5H), 7.48 (br s, 8H).

The above 3-O-benzyl-1,3-bis[(1,2-O-dimyristoyl-sn-glycero-3)phosphoryl]glycerol diammonium salt (1.75 g, 1.28 mmol) was dissolved in THF (40 mL) and hydrogenated with 10% Pd—C (600 mg) at a pressure of 50 psi for 4 hrs. After filtration on celite to remove the catalyst, the solution was evaporated to dryness; the residue was dissolved in chloroform (8 mL) and precipitated using acetone (60 mL). The mixture was kept in a freezer overnight and the white solid was filtered and washed with a small amount of cold acetone to get 6. Yield 1.39 g (85%). TLC (CHCl₃/MeOH/NH₄OH 65:25:5) R_{f}˜0.43. ¹H NMR (for 1,2-isomer) (6) ¹H NMR δ (CDCl₃, 500 MHz) 0.88 (t, J=7.0 Hz, 12H), 1.22-1.34 (m, 80H), 1.52-1.63 (m, 8H), 2.25-2.33 (m, 8H), 2.92 (bs, 1H), 3.59-3.69 (m, 2H), 3.86-3.98 (m, 6H), 4.12-4.18 (m, 2H), 4.28-4.39 (m, 3H), 5.16-5.23 (m, 2H), 7.43 (br s, 8H). ³¹P NMR δ (CDCl₃, 161 MHz, 85% H₃PO₄ as external standard) 0.34, 0.68. FTIR (ATR) 3220, 3034, 2957, 2919, 2872, 2851, 1737, 1466, 1416, 1378, 1345, 1328, 1293, 1279, 1255, 1202, 1181, 1093, 1063, 980, 836, 764, 721, 530 cm⁻¹. ESI-MS (negative), m/z 1239.9 (M-2NH₄⁺+H⁺), 1011.6 (M-2NH₄⁺—RCOO⁻), 619.5 (M-2NH₄⁺)²⁻.

### EXAMPLE 3

This example demonstrates preparation of a cardiolipin-containing liposome composition of the invention. Small unilamellar vesicles are formed by mixing in a suitable solvent 19.1 μmole of cardiolipin, produced according to the methods described herein, 96.2 μmol of phosphatidyl choline and 64.6 μmol of cholesterol. After thorough stirring, the mixture is evaporated to dryness in a 50 ml round-bottom flask using a rotary evaporator. The subsequent dried lipid film is resuspended in 10 ml sterile non-pyrogenic water. After a 30 minute swelling time, the resulting suspension is sonicated in a fixed temperature bath at 25° C. for 15 minutes. The preparation of liposomes is then lyophilized with trehalose.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language is the specification should be construed as indicating any non-claimed element as essential to the practice of the invention.

Preferred embodiments of this invention are described herein, including the best mode known to the inventors for carrying out the invention. Variations of those preferred embodiments might become apparent to those of ordinary skill in the art upon reading the forgoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### REFERENCES

1. Arrigo, P. D.; Ferra, L. D.; Fantoni, G. P.; Scarcelli, D.; Servi, S.; and Strini, A. J. Chem. Soc. Perkin Trans. 1. 1996, 21, 2657-2660.
2. Keana, J. F. W.; Shimiju, M.; Jemstedt, K. K. J. Org. Chem. 1986, 51, 2297-2299.
3. Mishina, I. M.; Vasilenko, A. E.; Stepanov, A. E.; Shvets, V. I. Bioorg. Khim. 1987, 13, 1110-1115.
4. Mishina, I. M.; Vasilenko, A. E.; Stepanov, A. E.; Shvets, V. I. Zh. org. Khim. 1984, 20, 985-988.
5. Mishina, I. M.; Vasilenko, A. E.; Stepanov, A. E.; Shvets, V. I. Bioorg. Khim. 1985, 11, 992-994.
6. Ramirez, F.; Ioannou, P. V.; Marecek, J. F.; Dodd, G. H.; Golding, B. T. Tetrahedron. 1977, 33, 599-608.
7. Ramirez, F.; Ioannou, P. V.; Marecek, J. F.; Golding, B. T.; Dodd, G. H. Synthesis. 1976, 11, 769-770.
8. Inoue, K.; Nojima, S. Chem. Pharm. Bull. 1968, 16, 76-81.
9. Inoue, K.; Nojima, S. Chem. Pharm. Bull. 1963, 11, 1150-1156.
10. Saunders, R. M.; Schwarz. J. Am. Chem. Soc. 1966, 88, 3844-3847.
11. Duralski, A. A.; Spooner, P. J. R.; Rankin, S. E.; Watts, A. Tetrahedron Lett. 1998, 39, 1607-1610.
12. Krishna, U. M.; Ahmad, M. U.; Ahmad, I. Tetrahedron Lett. 2004, 45, 2077-2079.
13. Lin, Z.; Ahmad, M. U.; Ali, S. M.; Ahmad, I. Lipids, 2004, 39, 285-290.
14. Krishna, U. M.; Ahmad, M. U.; Ali, S. M.; Ahmad, I. Lipids, 2004, 39, 595-600.
15. Browne, J. E.; Driver, M. J.; Russel, J. C.; Sammes, P. G. J. Chem. Soc. Perkin Trans. 1. 2000, 653-657.
16. Beaucage, S. L.; and Iyer, R. P. Tetrahedron, 1993, 49, 10441-10488.
17. Watanabe, Y.; Hirofuji, H.; Ozaki, S. Tetrahedron Lett. 1994, 35, 123-124.
18. Watanabe, Y.; Nakamura, T.; Mitsumoto, H. Tetrahedron Lett. 1997, 42, 7407-7410.
19. Dodd, G. H.; Golding, B. T.; Ioannou, P. V. J. Chem. Soc. Perkin Trans. 1. 1976, 2273-2277.
20. Chong, J. M.; Sokoll, K. K.Organic Preparations and Procedures Int., 1993, 25, 639-647.

What is claimed is:

1 . A method for preparing a cardiolipin analogue of formulas I, II, III, IV or V 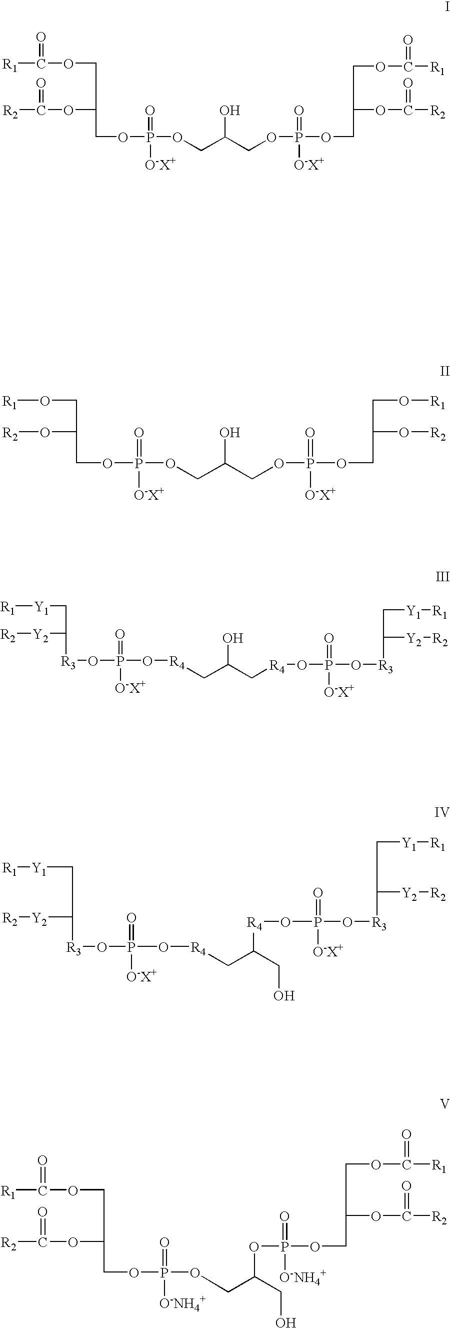
comprising reacting an alcohol of the formula VI 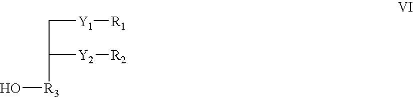
with one or more phosphoramidite reagents and unprotected glycerol in the presence of an acid catalyst to form protected cardiolipin.

2. The method of claim 1, wherein the phosphoramidite reagent is of formula VII.

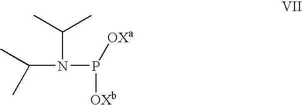

3. A method for preparing a cardiolipin analogue of formulas I, II, III, IV or V, comprising reacting unprotected glycerol with one or more phosphite triesters in the presence of an acid catalyst to form a protected cardiolipin.

4. The method of claim 3, wherein one or more of the phosphite triesters are produced by reacting an alcohol of formula VI with a phosphoramidite of general formula VII.

5. The method of claim 1, wherein
R₁ and R₂ are the same or different and are H, C₂ to C₃₄ saturated or unsaturated alkyl group;
X is a non-toxic cation;
Y and Y₂ are the same or different and are —O—C(O)—, —O—, —S—, or —NH—C(O)— or the like; and
R₃ is (CH₂)ₙ and n=0-15.

6. The method of claim 1, wherein R₄ is a linker, comprising alkyl, substituted alkyl, cycloalkyl, substituted cycloalkyl, alkyloxy, polyalkyloxy, substituted polyalkyloxy, a peptide, dipeptide, polypeptide, protein, carbohydrate and the like.

7. The method of claim 1, wherein R₄ is CH₂.

8. The method of claim 5, wherein the non-toxic cation is selected from a group consisting of hydrogen, ammonium, sodium, potassium, calcium and barium ion.

9. The method of claim 1, wherein at least one of R₁ and/or R₂ is a saturated or unsaturated alkyl group having between 4 and 14 carbons.

10-20. (canceled)

21. The method of claim 1, further comprising deprotecting the protected cardiolipin.

22. (canceled)

23. (canceled)

24. A cardiolipin analogue, prepared by the method of claim 1, wherein the cardiolipin analogue is an active agent used in the treatment of a human disease.

25. (canceled)

26. A method for preparing a cardiolipin analogue, comprising reacting an alcohol of the formula VI with one or more phosphoramidite reagents and 3-O-protected glycerol in the presence of an acid catalyst to form a protected cardiolipin.

27-40. (canceled)

41. The method of claim 26, wherein the acid catalyst is selected from a group consisting of 4,5-dichloroimidazole, 1H-tetrazole, 5-(4-nitrophenyl)-1H-tetrazole, 5-(3,5-dinitrophenyl)-1H-tetrazole, N-methylimidazolium triflate and N-methylimidazolium perchlorate.

42. The method of 26-41 claim 26, further comprising deprotecting the protected cardiolipin.

43. A cardiolipin or cardiolipin analogues prepared by the method of claim 26.

44. The cardiolipin analogue of claim 43, wherein the cardiolipin analogue is an active agent used in the treatment of a human disease.

45-86. (canceled)
